(19) United States
(12) Patent Application Publication
(10) Pub. No.: US 2022/0147924 A1
(43) Pub. Date: May 12, 2022

(54) FACILITATING FINANCING IN SUPPLY CHAIN MANAGEMENT USING BLOCKCHAIN

(71) Applicants: Lipika Sahoo, Bangalore (IN); Manoj Kumar Sahoo, Bangalore (IN)

(72) Inventors: Lipika Sahoo, Bangalore (IN); Manoj Kumar Sahoo, Bangalore (IN)

(73) Assignees: Lipika Sahoo, Bangalore (IN); Manoj Kumar Sahoo, Bangalore (IN)

(21) Appl. No.: 17/429,751

(22) PCT Filed: Feb. 10, 2020
(86) PCT No.: PCT/IN2020/050134

§ 371 Date: Aug. 10, 2021

(30) Foreign Application Priority Data
Feb. 10, 2019 (IN) 201941005203

(51) Int. Cl. G06Q 10/08; G06Q 40/02; H04L 9/32

(52) U.S. Cl. CPC G06Q 10/0835; G06Q 10/0833; H04L 2209/56; H04L 9/3236; H04L 2209/38; G06Q 40/025

(57) ABSTRACT

An aspect of the present invention facilitates financing in supply chain management (SCM). In one embodiment, one or more systems maintains in a blockchain, multiple transactions performed as part of the SCM. Upon a borrower sending a request for financial assistance to a financial entity, the financial entity is provided with a set of transactions (maintained in the blockchain) related to the borrower. The borrower receives a response indicating a decision on the request for financial assistance, the decision being based on at least some of the set of transactions provided to the financial entity.

### BACKGROUND OF THE INVENTION

### Technical Field

The present disclosure relates to supply chain management (SCM) systems and more specifically to facilitating financing in supply chain management using blockchain.

### Related Art

Supply chain management (SCM), as is well known, refers to the management of the flow of goods and services, involves the movement and storage of raw materials, of work-in-process inventory, and of finished goods from point of origin to point of consumption. As is well known, SCM plays a vital role in keeping enterprise cost minimum and high profitability. Some of the factors/flows involved in SCM include, without limitation, Product flow, Information flow and Finances flow.

One specific industry where SCM is vital is the agriculture industry where agricultural products (e.g. fruits and vegetables, milk, etc.) are produced, transported and consumed. However, there are several challenges to implementing SCM for the agriculture industry.

As many agricultural products (e.g. fruits and vegetables) are perishable, the industry attracts high marketing costs, market gluts, price fluctuations and other similar problems. For example, post-harvest loss of fruits and vegetables accounts for a large percentage (about 25% to 30%) of production, leading to low per capita availability of fruits and vegetables. A sizable quantity of the produce also deteriorates by the time it reaches the consumer.

On the other hand, consumers (e.g. people living in cities) are becoming health and hygiene conscious. Instead of conventional wet markets, the consumers prefer to buy vegetables, fruits and other agricultural products from the super markets and modern retail outlets, and with time it is expected to be delivered to their home or workplace.

Processing increases market opportunities for fresh fruits and vegetables and adds value while minimizing postharvest losses. Furthermore, processing improves the viability, profitability and sustainability of fruit and vegetable production systems by increasing farm incomes, and generating rural employment and foreign exchange.

Traditional processing technologies offer considerable opportunities for innovation and vertical diversification in the fruit and vegetable sector, relatively few small and medium enterprises (SMEs) are able to tap into and benefit from these opportunities. Many SMEs lack the capacity to operate competitively in the current globalized market environment owing to problems of scale, the poor quality of input supplies, poor access to technology, limited technical expertise and research capacity, low production efficiency, high marketing cost, lack of knowledge and consequently inability to comply with international standards for processed products.

So, there is a need for efficient supply chain management system to help farmers to sell their produce at optimal price, which can create opportunities for small to medium enterprise. In addition, there is also a need for processing of food and vegetables can minimize post-harvest loss, increase half-life of fruits, vegetables and agricultural products.

As is well known, a blockchain is an incorruptible digital distributed ledger of transactions. Information held on a blockchain exists as a shared and continually reconciled database. The blockchain database isn't stored in any particular location, rather the records are kept at individual location and easily verifiable instead of a centralized location. That means no centralized version of the information exists for a hacker to tamper the data. As the blockchain data is hosted by millions of computers simultaneously, it is almost impossible to corrupt the data. And the data is accessible to anyone over the Internet.

The inventors have determined that blockchains can play a vital role in enabling the agriculture sector. Specifically, an efficient supply chain management (SCM) with a blockchain based digital ledger of transactions overcomes one or more of the above noted challenges. Aspects of the present invention are directed to providing an efficient blockchain based SCM system, in particular to facilitate financing in supply chain management.

### SUMMARY OF THE INVENTION

An aspect of the present invention facilitates financing in supply chain management (SCM). In one embodiment, one or more systems maintains in a blockchain, multiple transactions performed as part of the SCM. Upon a borrower (e.g. a farmer/supplier, consumer) sending a request for financial assistance to a financial entity (e.g. a Bank), the financial entity is provided with a set of transactions (maintained in the blockchain) related to the borrower. The borrower receives a response indicating a decision on the request for financial assistance, the decision being based on at least some of the set of transactions provided to the financial entity.

According to another aspect of the present invention, the one or more system provides the set of transactions upon receiving, from the borrower, an authorization for the financial entity to access the set of transactions. Based on the authorization, the financial entity retrieves the set of transactions and determines the decision on the request.

In one embodiment, each transaction (maintained in the blockchain) captures information on a set of goods and the interaction between two or more SCM entities with respect to the set of goods. The SCM entities includes a supplier, a logistic provider and a customer.

According to one more aspect of the present invention, the borrower (noted above) is the supplier, and as such the set of transactions includes invoice details of the goods provided by the supplier and shipment tracking details of the goods from the supplier to the customer.

According to yet another aspect of the present invention, the borrower (noted above) is the customer, and as such the set of transactions includes invoice details of the goods provided to the customer and shipment tracking details of the goods from the supplier to the customer.

According to an aspect of the present invention, the one or more systems also (in addition to the above noted set of transactions) provides additional data based on the historical analysis of the transactions maintained in the blockchain.

According to another aspect of the present invention, the financial assistance comprises a financial asset provided (by the financial entity) to the borrower as a response to the request. Accordingly, the one or more systems facilitates monitoring at least the set of transactions to determine a status of the financial asset. In one embodiment, the financial asset comprises a loan provided to the borrower based on the set of transactions.

According to one aspect of the present invention, the one or more systems facilitates the financial entity to share the set of transactions with a regulatory entity.

Thus, according to several aspects of the present invention, a supplier (e.g. farmer) is provide access to financial assistance from financial institutions depending on the values of the transactions/contracts and the consumer credit rating. The financial institutions are also enabled to block the limit of a consumer keeping the contract/transaction value in consideration and disburse a loan (financial asset) to the supplier/farmer as advance payment.

In addition, aspects of the present invention facilitate blockchain based sharing of information with desired third-parties (e.g. regulatory body, Government, etc.) and such a feature can be extended to suppliers/farmers using a simplified user interface, wherein the technology platform abstracts all the complexity involved from all stakeholders involved in the block chain.

A blockchain based SCM system will enable the suppliers (farmers) and other stakeholders like SME for supplying, processing and easy selling of agricultural products (fruits and vegetables). The system coupled with processing of the agricultural products will lead to easy flow of information among different stake holders. The flow of information will enable financial institutions and insurance organizations to invest in the agricultural industry/sector. Such a system also would help prevention of exploitation of farmers/SME and help increase their income.

A blockchain based SCM system also will enable agricultural products to be transported efficiently from farmers/growers to end users/consumers. The system also simplifies supply of agricultural products (or goods generate thereof) directly to consumer with or without third parties (logistics provider, shipper, etc.) in the supply chain. The system also facilitates direct payment to farmers/growers which will enhance their margin of income.

Several aspects of the invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### BRIEF DESCRIPTION OF THE DRAWINGS

Example embodiments of the present invention will be described with reference to the accompanying drawings briefly described below.

FIGS. 1A and 1B are block diagrams illustrating an example environment in which various aspects of the present invention can be implemented.

FIG. 2 is a flow chart illustrating the manner in which financing in SCM is facilitated using blockchain according to aspects of the present invention.

FIGS. 3A-3C illustrate an example implementation of a blockchain based SCM in one embodiment.

FIGS. 4A-4D illustrate some of the concepts of blockchain technology used for providing several aspects of the present invention.

FIG. 5 is a block diagram illustrating the details of a digital processing system in which various aspects of the present invention are operative by execution of appropriate execution modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

1. Example Environment

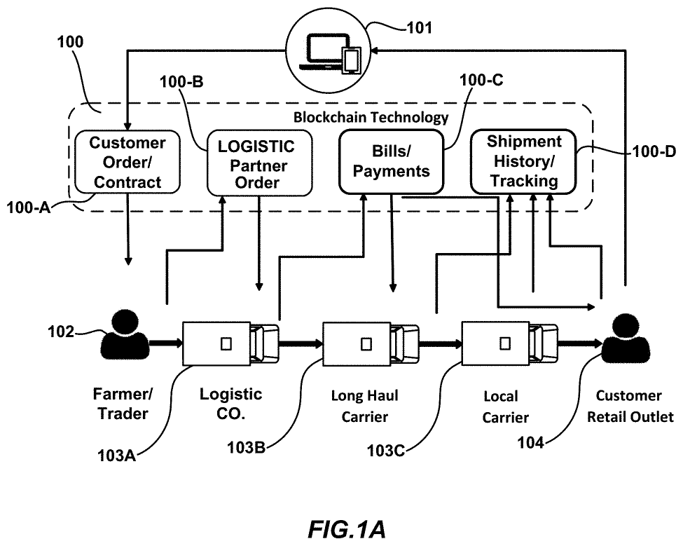

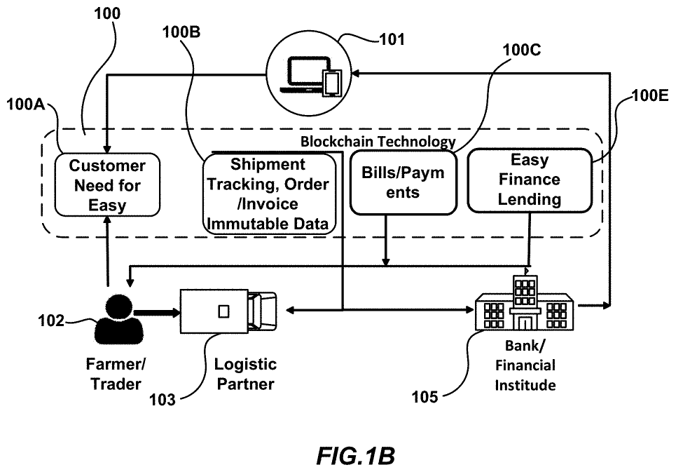

FIGS. 1A and 1B are block diagrams illustrating an example environment in which various aspects of the present invention can be implemented. The example environment is shown containing blockchain based SCM system 100 (in turn shown containing components 100A-100D), client device 101, farmer/trader 102, logistic company 103A, long haul courier 103B, local carrier 103C (with 103A-103C being together referred to as logistic partner 103), customer/retail outlet 104 and bank/financial institution 105.

Merely for illustration, only representative number/type of systems is shown in FIGS. 1A and 1B. Many environments often contain many more systems/entities, both in number and type, depending on the purpose for which the environment is designed. Each system/entity of FIGS. 1A and 1B is described below in further detail.

Client device 101 represents a system (computing device) such as a personal computer, workstation, mobile phones (e.g. iPhone available from Apple Corporation), tablets, portable devices (also referred to as “smart” devices”) that operate with a generic operating system such as Android operating system available from Google Corporation, etc., used by users to send (client) requests to other systems such as blockchain based SCM system 100.

In general, client device 101 enables an end-user to send client requests for performing desired tasks to another system, to receive corresponding responses containing the results of performance of the requested tasks and to view corresponding responses received for the client requests. In addition, client devices 101 is also capable of receiving (push) notifications from external systems.

Blockchain based SCM system 100 (herein after “B-SCM 100”) represents an efficient SCM along with a blockchain based digital ledger of transactions provided according to several aspects of the present invention. Though shown as a single block, it should be appreciated that B-SCM 100 is typically implemented using one or more systems that co-operatively provide the aspects of the present invention.

B-SCM 100 facilitates the various SCM entities such as farmer/trader 102 (supplier), logistic partner 103 (logistic provider), customer/retail outlet 104 and bank/financial institution 105 to perform various transactions. Examples of some transactions that may be performed are described in detail below.

Referring to FIG. 1A, the first event is farmer 102 publishing that the supply of an agricultural product is available or customer 104 (including the processing SME/retailer) indicating the demand for an agricultural product (using a mobile app or a web portal provided on client device 101). Farmer 102 and customer 104 get into a contract, which is stored in a blockchain. The contract rate can be made public or stored as private (visible only to farmer 102 and customer 104). All the other stakeholders (SCM entities) like logistic partner 103 and financial institution 105 can access this information (based on the privacy terms).

The second event is logistic partner 103 (like post-man) picking up the package from supplier (farmer 102). The pick-up information is also pushed to/stored in the blockchain via a sensor. Periodic transmission from sensor to blockchain will ensure that the shipment tracking is visible to all the stakeholders. In case of a perishable goods, the temperature information may also be pushed by sensor to the blockchain.

The third event is delivery of the package to customer 104. The delivery information is pushed to the blockchain. Based on the contract, a corresponding payment is initiated from customer 104 to farmer 102. All related information is also stored and made available in blockchain for historical information and regulatory reports if required.

Referring to FIG. 1B, the first event occurs similar to that noted above. As the second event, financial institution, based on the credit rating of consumer/contract value and terms and conditions, decides the loan amount for farmer 102. The loan amount is disbursed to farmer 102 and the related information is stored in the blockchain. Farmer 102 indicates when the supply is ready, which is also stored in the block chain. The next two events are similar to the second and third event described above. However, the payment to farmer 102 is initiated based on the contract, but after adjusting the loan amount and interest. All related information is pushed to the blockchain.

The manner in which B-SCM 100 facilitates financing in SCM using blockchains is described below with examples.

2. General Flow

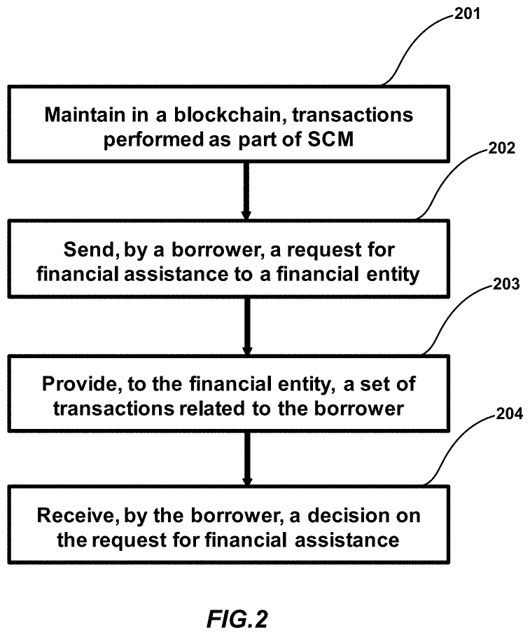

FIG. 2 is a flow chart illustrating the manner in which financing in SCM is facilitated using blockchain according to aspects of the present invention. The flowchart is described with respect to FIGS. 1A and 1B, in particular B-SCM 100, merely for illustration. However, various features can be implemented in other systems and/or other environments also without departing from the scope of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention.

In step 201, B-SCM 100 maintains in a blockchain, transactions performed as part of SCM. Each transaction (maintained in the blockchain) captures information on a set of goods (e.g. fruits and vegetables) and the interaction between two or more SCM entities (farmer 102, logistic partner 103, customer 104, bank 105) with respect to the set of goods.

In step 202, B-SCM 100 enables a borrower (farmer 102, customer 104) to send a request for financial assistance to a financial entity (e.g. bank 105). The request may be received from a client device (similar to 101) used by the borrower.

In step 203, B-SCM 100, in response to the request, provides, to the financial entity, a set of transactions related to the borrower. According to an aspect, B-SCM 100 provides the set of transactions upon receiving, from the borrower, an authorization for the financial entity to access the set of transactions. Based on the authorization, the financial entity retrieves the set of transactions and determines a decision on the request.

The set of transactions provided may be based on the borrower. For example, when the borrower is a supplier (farmer 102), the set of transactions includes invoice details of the goods provided by the supplier and shipment tracking details of the goods from the supplier to the customer. When the borrower is a customer (104), the set of transactions includes invoice details of the goods provided to the customer and shipment tracking details of the goods from the supplier to the customer.

The invoice details may include, without limitation, Invoice Date, Invoice Amount, Other Party details (Buyer—Name, Address, Bank A/c etc), Item details (supplied), Shipment Date, Shipping Organization, etc. The shipment tracking details may include, without limitation, Shipment Tracking id, Shipment date, Location historical data, Destination Location, consignee (buyer) details, etc.

According to an aspect, B-SCM also (in addition to the above noted set of transactions) provides additional data based on the historical analysis of the transactions maintained in the blockchain. The additional data may include, without limitation, Top 10 Sales in the last financial year, Top 10 buyer for the last financial year, Days sales outstanding (DSO), etc.

In step 204, B-SCM 100 facilitates the borrower to receive a response indicating a decision on the request for financial assistance, the decision being based on at least some of the set of transactions provided to the financial entity.

It may be appreciated that the shared data (transactions, historical analysis based additional data) is based on the authorization from the borrower (e.g. farmer 102) and cannot be tampered (immutable property) in a block chain, the shared data is the most reliable/trusted/real-time data which a financial institution (bank 105) can get to take the decision on financing.

Thus, B-SCM 100 facilitates financing in SCM using blockchain. According to aspect, the financial assistance comprises a financial asset (e.g. loan) provided (by the financial entity) to the borrower as a response to the request. Accordingly, B-SCM 100 facilitates monitoring at least the set of transactions to determine a status of the financial asset. According to another aspect, B-SCM 100 facilitates the financial entity (bank 105) to share the set of transactions with a regulatory entity (e.g. central bank, Government, etc.)

The manner in which a blockchain based SCM system according to the operation of FIG. 2 may be implemented is described below with examples.

3. Example Implementation

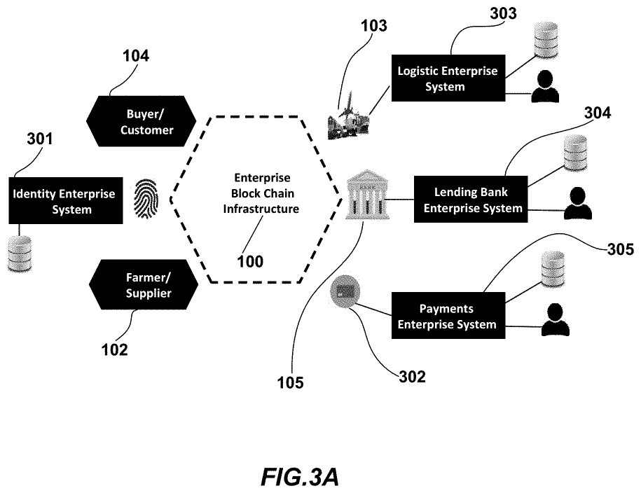

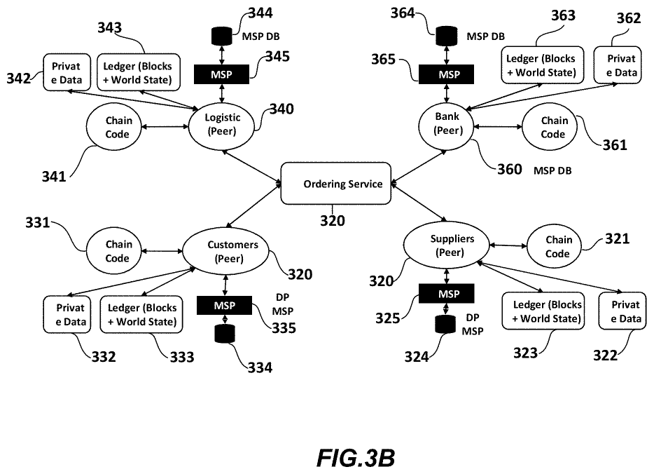

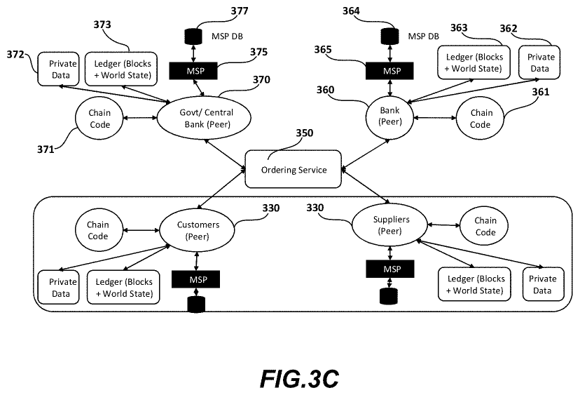

FIGS. 3A-3C illustrate an example implementation of a blockchain based SCM (100) in one embodiment. The blocks of the implementation are described in detail below.

Each of MSP (Membership service provider) 325, 335, 345, 365 and 375 is responsible for creating digital identity for an entity (like Banks, Suppliers, Customers etc.) and user of these organizations. Each MSP component provides a mechanism of registering users from an entity (network members) and responsible for issuing them digital certificate (X. 509 certificate). This is configured with a corresponding backend DB (PostgreSQL or MySQL) 324, 334, 344, 364 and 374 which stores the registered identities and their X. 509 certificates (not the private key of user)). In one embodiment, the MSP component runs inside a Docker container.

Each of Peers (Banks, Suppliers, Customers and Logistic partners) 320, 330, 340, 360 and 370 is an entity which participate in the block chain network and its identity is determined by its corresponding MSP (1). The peer is responsible for deploying and instantiating chain code (smart contract), Updating the block chain ledger, interacting with other peers (stakeholders) to share private data associated with transactions, and interacting with ordering service as well as smart contracts (chain code) as shown in the architecture diagram of FIG. 3A. In one embodiment, the peer component also runs inside a Docker Container.

Each of Smart Contract/Chain code 321, 331, 341, 361 and 371 is the application logic in high level language (Java scripts), when executed successfully, writes or reads data that eventually gets committed to the ledger. This does not have direct access to the ledger.

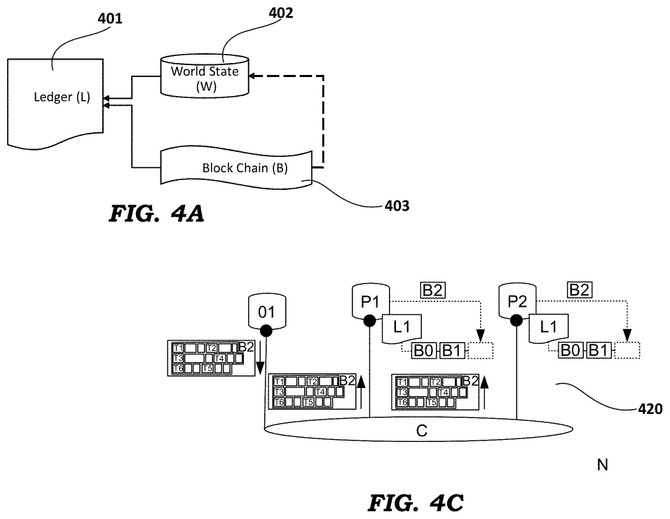

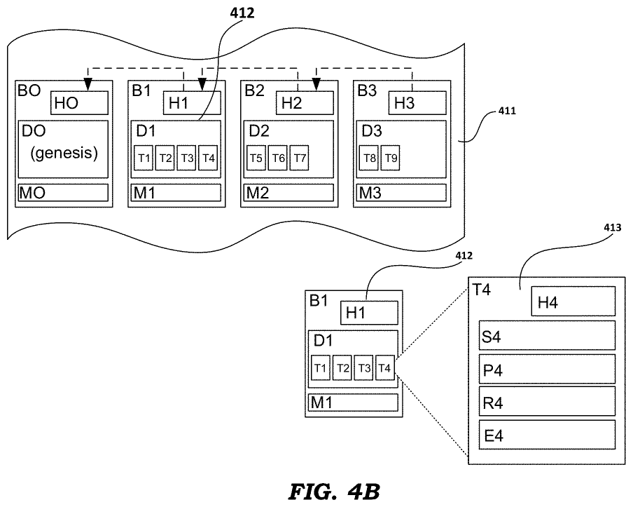

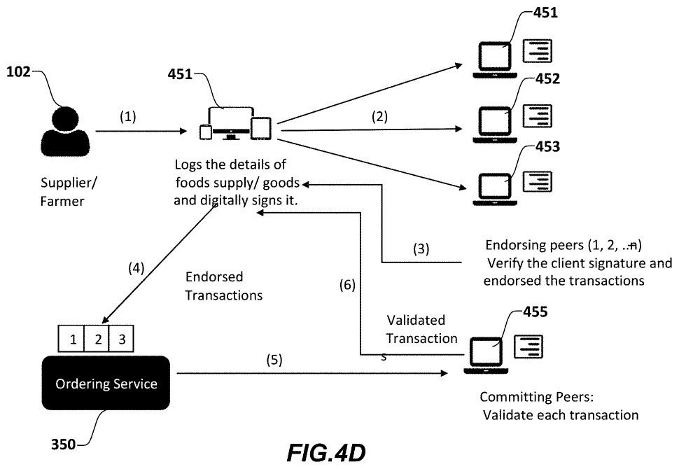

Each of Ledger 323, 333, 343, 363 and 373 which contains record of all committed transactions which the peer has received, and is maintained by the corresponding peer. The entries in ledger are stored as key/value pairs. Updates to the same key will replace the current value of a key with new value. The old value, also will stay in the ledger—block chain. For efficient querying the latest value of a key, a node stores the latest value of each key in DB is referred as world state in FIG. 4A.

Ordering services 350 is responsible for receiving the executed transactions from peers, combining them into blocks and broadcasting them to other participating peers. The peers receiving the transactions blocks then validate it before committing it to their ledger. Some of the concepts of blockchain technology used are described below with examples.

FIGS. 4A-4D illustrate some of the concepts of blockchain technology used for providing several aspects of the present invention. In FIG. 4A, ledger 401 is the ledger described below and is shown containing world state (W) 402 and Block chain (B) 403. In FIG. 4B, blockchain 411 represents a portion of blockchain (B) 403, and is shown containing B0, B1, B2, B3. B0 is the first block in the blockchain, the genesis block. Each block (B1) has a block data (D1) which contains all its transactions: T1, T2, T3 and T4. H1 contains a cryptographic hash of all the transactions of D1 as well as with the equivalent hash from the previous block B0.

In addition, the transaction details of a transaction stored in blockchain is shown in FIG. 4B. In particular, Transaction T4 in Block data D1 of block B1 consists of transaction header, H4, a transaction signature, S4, a transaction proposal P4, a transaction response, R4, and a list of endorsements, E4.

Header section, illustrated by H4, captures some essential metadata about the transaction—for example, the name and its version. Signature section, illustrated by S4, contains a cryptographic signature, created by the client application. This field is used to check that the transaction details have not been tampered with, as it requires the application's private key to generate it. Proposal field, illustrated by P4, encodes the input parameters supplied by an application to the smart contract which creates the proposed ledger update. When the smart contract runs, this proposal provides a set of input parameters, which, in combination with the current world state, determines the new world state.

Response section, illustrated by R4, captures the before and after values of the world state, as a Read Write set (RW-set). It's the output of a smart contract, and if the transaction is successfully validated, it will be applied to the ledger to update the world state. Endorsements as shown in E4, is a list of signed transaction responses from each required organization sufficient to satisfy the endorsement policy.

FIG. 4C illustrates the manner in which ordering service 350 (O1 here) distributes and stores transactions in a blockchain. Orderer O1 distributes block B2 to peer P1 and peer P2. Peer P1 processes block B2, resulting in a new block being added to ledger L1 on P1. In parallel, peer P2 processes block B2, resulting in a new block being added to ledger L1 on P2. Once this process is complete, the ledger L1 has been consistently updated on peers P1 and P2, and each may inform connected applications that the transaction has been processed.

FIG. 4D illustrates the manner in which transactions are endorsed by peers in one embodiment. In step 1, a supplier/farmer (102) logs the details of foods supply/goods and digitally signs it (in system 451). In step 2, the logged information is shared with one or more peers (using systems 452-454). In step 3, endorsing peers verify the client signature and endorses the transactions. In step 4, the endorsed transactions are sent to ordering service 350. In step 5, the endorsed transactions are sent to committing peers (using systems 455), who validate each transaction. In step 6, the validated transactions are committed in the blockchain.

It may be appreciated that use of blockchain based SCM in agricultural industry facilitates employment generation, value added products and minimization of product losses. The invention also provides specific advantages as would be appreciated by a person in the art such as: Reduction of product losses in transportation and storage; Increasing of sales; Dissemination of technology, capital and knowledge among the chain partners; Better information about the flow of products, markets and technologies; Transparency of the supply chain; Tracking and tracing to the source; Better control of product safety and quality; Large investments and risks are shared among partners in the chain; Productivity Improvement; High customer satisfaction; Increased profit; and On time delivery.

According to a non-limiting exemplary aspect of the present invention, the best way to practice the invention: to incorporate it as robust system supply chain for fruits, vegetables and agricultural products; and to enable financial institutions to directly pay farmers and growers, increasing their profitability.

It should be further appreciated that the above noted features can be implemented in various embodiments as a desired combination of one or more of hardware, execution modules and firmware. The description is continued with respect to one embodiment in which various features are operative when execution modules are executed.

4. Digital Processing System

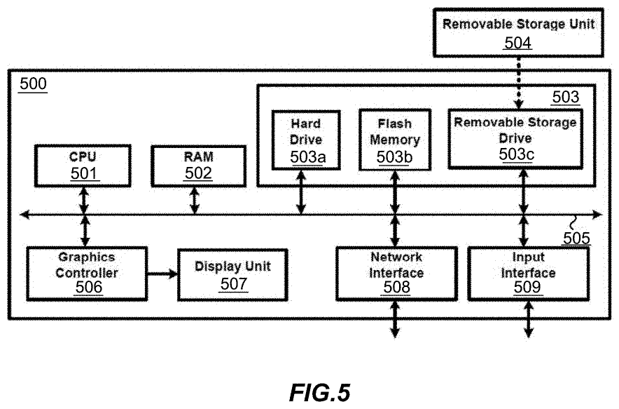

FIG. 5 is a block diagram illustrating the details of digital processing system 500 in which various aspects of the present invention are operative by execution of appropriate execution modules. Digital processing system 500 may correspond to one or more systems of FIGS. 1A-1B and 3A-3C.

Digital processing system 500 may contain one or more processors (such as a central processing unit (CPU) 501), random access memory (RAM) 502, secondary memory 503, graphics controller 506, display unit 507, network interface 508, and input interface 509. All the components except display unit 507 may communicate with each other over communication path 505 which may contain several buses as is well known in the relevant arts. The components of FIG. 5 are described below in further detail.

CPU 501 may execute instructions stored in RAM 502 to provide several features of the present invention. CPU 501 may contain multiple processing units, with each processing unit potentially being designed for a specific task. Alternatively, CPU 501 may contain only a single general-purpose processing unit. RAM 502 may receive instructions from secondary memory 503 using communication path 505.

Graphics controller 506 generates display signals (e.g., in RGB format) to display unit 507 based on data/instructions received from CPU 501. Display unit 507 contains a display screen to display the images defined by the display signals. Input interface 509 may correspond to a keyboard and a pointing device (e.g., touch-pad, mouse), which enable the various inputs to be provided.

Network interface 508 provides connectivity to a network (e.g., using Internet Protocol), and may be used to communicate with other connected systems. Network interface 508 may provide such connectivity over a wire (in the case of TCP/IP based communication) or wirelessly (in the case of WIFI, Bluetooth based communication).

Secondary memory 503 may contain hard drive 503a, flash memory 503b, and removable storage drive 503c. Secondary memory 503 may store the data and software instructions (e.g., for implementing the steps of FIG. 2, the blocks of FIGS. 3B and 3C), which enable digital processing system 500 to provide several features in accordance with the present invention.

Some or all of the data and instructions may be provided on removable storage unit 504, and the data and instructions may be read and provided by removable storage drive 503c to CPU 501. Floppy drive, magnetic tape drive, CD-ROM drive, DVD Drive, Flash memory, removable memory chip (PCMCIA Card, EPROM) are examples of such removable storage drive 503c.

Removable storage unit 64 may be implemented using storage format compatible with removable storage drive 503c such that removable storage drive 63c can read the data and instructions. Thus, removable storage unit 504 includes a computer readable storage medium having stored therein computer software (in the form of execution modules) and/or data.

However, the computer (or machine, in general) readable storage medium can be in other forms (e.g., non-removable, random access, etc.). These “computer program products” are means for providing execution modules to digital processing system 500. CPU 501 may retrieve the software instructions (forming the execution modules) and execute the instructions to provide various features of the present invention described above.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology herein is for the purpose of description and should not be regarded as limiting.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

All documents cited in the present specification are hereby incorporated by reference in their totality. In particular, the teachings of all documents herein specifically referred to are incorporated by reference.

I/We claim:

1. A method of facilitating financing in supply chain management (SCM), the method being performed by one or more systems, the method comprising:
maintaining in a blockchain, a plurality of transactions performed as part of the SCM;
sending, by a borrower, a request for financial assistance to a financial entity;
providing, to the financial entity, a set of transactions of the plurality of transactions related to the borrower; and
receiving, by the borrower, a response indicating a decision on the request for financial assistance, wherein the decision is based on at least some of the set of transactions provided to the financial entity.

2. The method of claim 1, wherein the providing comprises receiving, from the borrower, an authorization for the financial entity to access the set of transactions,
wherein the financial entity retrieves the set of transactions and determines the decision on the request.

3. The method of claim 2, wherein each transaction captures information on a set of goods and the interaction between two or more of a plurality of SCM entities with respect to the set of goods.

4. The method of claim 3, wherein the plurality of SCM entities includes a supplier, a logistic provider and a customer.

5. The method of claim 4, wherein the borrower is the supplier, wherein the set of transactions includes invoice details of the goods provided by the supplier and shipment tracking details of the goods from the supplier to the customer.

6. The method of claim 4, wherein the borrower is the customer, wherein the set of transactions includes invoice details of the goods provided to the customer and shipment tracking details of the goods from the supplier to the customer.

7. The method of claim 4, wherein the providing also provides additional data based on the historical analysis of the plurality of transactions.

8. The method of claim 1, wherein the financial assistance comprises a financial asset provided to the borrower as a response to the request, the method further comprising monitoring at least the set of transactions to determine a status of the financial asset.

9. The method of claim 8, wherein the financial asset comprises a loan provided to the borrower based on the set of transactions.

10. The method of claim 8, further comprising sharing, by the financial entity, the set of transactions with a regulatory entity.

11. One or more systems configured to perform the actions of:
maintaining in a blockchain, a plurality of transactions performed as part of the SCM;
sending, by a borrower, a request for financial assistance to a financial entity;
providing, to the financial entity, a set of transactions of the plurality of transactions related to the borrower; and
receiving, by the borrower, a response indicating a decision on the request for financial assistance, wherein the decision is based on at least some of the set of transactions provided to the financial entity.

12. The one or more systems of claim 11, wherein the providing comprises receiving, from the borrower, an authorization for the financial entity to access the set of transactions,
wherein the financial entity retrieves the set of transactions and determines the decision on the request.

13. The one or more systems of claim 12, wherein each transaction captures information on a set of goods and the interaction between two or more of a plurality of SCM entities with respect to the set of goods.

14. The one or more systems of claim 13, wherein the plurality of SCM entities includes a supplier, a logistic provider and a customer.

15. The one or more systems of claim 14, wherein the borrower is the supplier, wherein the set of transactions includes invoice details of the goods provided by the supplier and shipment tracking details of the goods from the supplier to the customer.

16. The one or more systems of claim 14, wherein the borrower is the customer, wherein the set of transactions includes invoice details of the goods provided to the customer and shipment tracking details of the goods from the supplier to the customer.

17. The one or more systems of claim 14, wherein the providing also provides additional data based on the historical analysis of the plurality of transactions.

18. The one or more systems of claim 11, wherein the financial assistance comprises a financial asset provided to the borrower as a response to the request, further performing the actions of monitoring at least the set of transactions to determine a status of the financial asset.

19. The one or more systems of claim 18, wherein the financial asset comprises a loan provided to the borrower based on the set of transactions.

20. The one or more systems of claim 18, further performing the actions of sharing, by the financial entity, the set of transactions with a regulatory entity.
